(19) United States
(12) Patent Application Publication
(10) Pub. No.: US 2025/0020251 A1
(43) Pub. Date: Jan. 16, 2025

(54) CABLE JOINT FOR SECURELY CONNECTING A CABLE TO A GUIDE RAIL

(71) Applicant: SHIGEKI ARIMOTO, Bloomfield Hills, MI (US)

(72) Inventor: SHIGEKI ARIMOTO, Bloomfield Hills, MI (US)

(21) Appl. No.: 18/219,707

(22) Filed: Jul. 10, 2023

(51) Int. Cl. F16L 37/098

(52) U.S. Cl. CPC F16L 37/098; E05F 15/6909

(57) ABSTRACT

A cable joint for securely connecting a cable to a guide rail of a window regulator assembly comprising a first locking member configured to engage with a second locking member on the guide rail. The first locking member comprises grooves and snap arms with projections, and the second locking member comprises a slot and one or more notches. The projections configured to engage with the one or more notches to form a snap-fit joint onto the guide rail temporally. The projections of the first locking member configured with a first slope and a second slope. The first slope comprises a steep angle configured to prevent the cable joint from coming out from the guide rail, and the second slope comprises a slight angle configured to push the cable joint into the slot of the guide rail. The force to remove the cable joint from the guide rail to be reduced by removing the cable from the cable joint.

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### TECHNICAL FIELD

The disclosed subject matter relates generally to a cable joint. More particularly, the present disclosure relates to a cable joint securely connecting a cable to a guide rail of a window regulator assembly.

### BACKGROUND

In various industries, cable joints are essential components used in different applications. Cable joints are commonly employed to connect and secure cables, and they are utilized in conjunction with a guide rail. However, these cable joints encounter fitting-related issues in their existing configurations.

Traditional cable joints face two primary fitting challenges during assembly. Firstly, the cables often detach too easily from the joints, leading to unstable connections and potential safety hazards. Secondly, some cable joints have excessively tight fits, making it difficult to properly assemble the cables and joints together. These issues result in prolonged installation times, increased labor costs, and the risk of damage to the cables and joint components. Similarly, cable joints used with guide rails encounter persistent fitting problems. If the fitting condition is loose, the cable joint may detach easily from the guide rail during the assembly process, causing manufacturing issues. Moreover, loose fittings can contribute to noise problems after assembly, leading to quality concerns. Conversely, if the fitting condition is too tight, it becomes challenging to assemble the cable joint into the guide rail, potentially resulting in non-build conditions. Despite attempts to address these issues by incorporating crash ribs to accommodate guide rail thickness, consistent dimensional control remains elusive. Given these common fitting challenges faced by cable joints, there is a need to develop an innovative solution that addresses these issues comprehensively, providing secure and efficient fittings for enhanced performance in various industries.

In the light of the aforementioned discussion, there exists a need for a certain assembly with novel methodologies that would overcome the above-mentioned challenges.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards a cable joint for securely connecting a cable to a guide rail of a window regulator assembly.

An objective of the present disclosure is directed towards a window regulator assembly with a snap-fit feature to lock the cable joint onto a guide rail and provide easy assembly and good quality.

Another objective of the present disclosure is directed towards a cable joint made of either resin material or flexible material.

Another objective of the present disclosure is directed towards a guide rail made of either aluminum, steel, or resin.

Another objective of the present disclosure is directed towards cable joint that includes one or more projections formed on the snap arms that are designed to temporarily engage with one or more notches on the guide rail thereby ensuring easy assembly.

Another objective of the present disclosure is directed towards the cable joint that includes one or more projections formed on the snap arms configured to prevent high installation effort and looseness due to the thickness variation of a guide rail material.

Another objective of the present disclosure is directed towards enabling a user to facilitate the removal of the cable joint from the guide rail by initially removing the cable.

Subsequently, the cable joint can be easily extracted.

According to an exemplary aspect of the present disclosure, a cable joint for securely connecting a cable to a guide rail of a window regulator assembly includes a first locking member configured to engage with a second locking member.

According to another exemplary aspect of the present disclosure, a first locking member configured to engage with a second locking member.

According to another exemplary aspect of the present disclosure, a first locking member comprises one or more grooves and snap arms with projections.

According to another exemplary aspect of the present disclosure, a second locking member comprises a slot and one or more notches.

According to another exemplary aspect of the present disclosure, the one or more projections formed on the snap arms configured to engage with the one or more notches thereby forming a snap-fit joint onto the guide rail temporally.

According to another exemplary aspect of the present disclosure, projections of the first locking member configured with a first slope and a second slope.

According to another exemplary aspect of the present disclosure, the first slope includes a steep angle configured to prevent the cable joint from coming out from the guide rail, and the second slope includes a slight angle configured to push the cable joint into the slot of the guide rail.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1A is an example diagram depicting a window regulator assembly for controlling the movement of vehicle side door windows, in accordance with one or more exemplary embodiments.

FIG. 1B is an example diagram depicting a detailed view of a guide rail, in accordance with one or more exemplary embodiments.

FIG. 2 is an exemplary diagram depicting a cable joint, in accordance with one or more exemplary embodiments.

FIG. 3A is an exemplary diagram depicting the detailed view of a cable joint and a guide rail, in accordance with one or more exemplary embodiments.

FIG. 3B is an exemplary diagram depicting a cable joint engaged with a guide rail, in accordance with one or more exemplary embodiments.

FIG. 3C is an exemplary diagram depicting section view A-A of a cable joint engage with a guide rail, in accordance with one or more exemplary embodiments.

FIG. 3D is an exemplary diagram depicting the section view B-B of a cable joint engage with a guide rail, in accordance with one or more exemplary embodiments.

FIG. 3E is an exemplary diagram depicting a first slope and a second slope of the projections of a first locking member of a cable joint, in accordance with one or more exemplary embodiments.

FIG. 3F is an exemplary diagram depicting inserting cable into a cable joint, in accordance with one or more exemplary embodiments.

FIG. 3G is an exemplary diagram depicting a cable joint engaging to a guide rail after removing a cable, in accordance with one or more exemplary embodiments.

FIG. 4 is another example diagram depicting the window regulator guide rail assembly with a guide rail bracket comprising the second locking member, in accordance with one or more exemplary embodiments.

Furthermore, the objects and advantages of this invention will become apparent from the following description and the accompanying annexed drawings.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

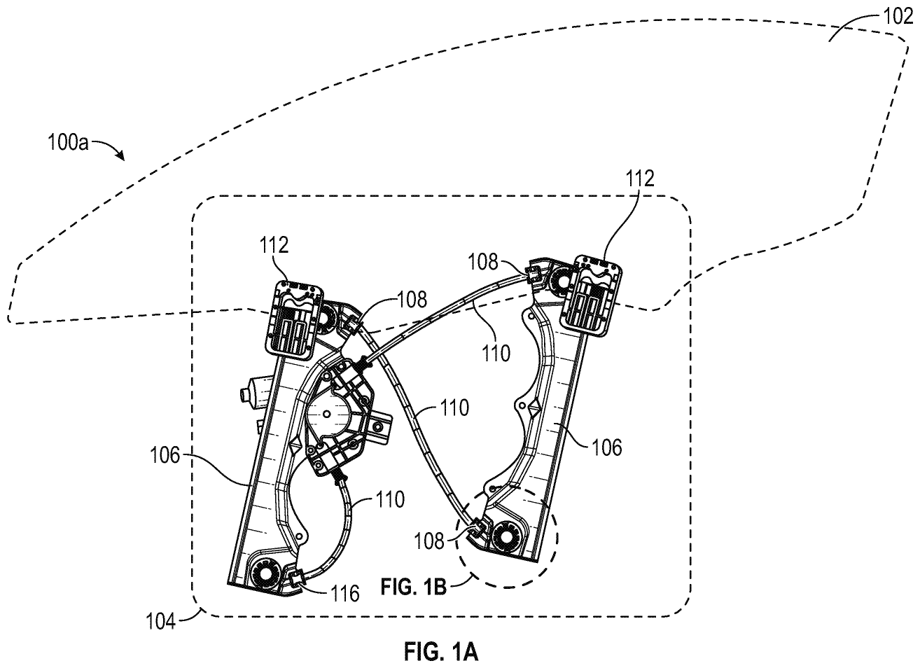

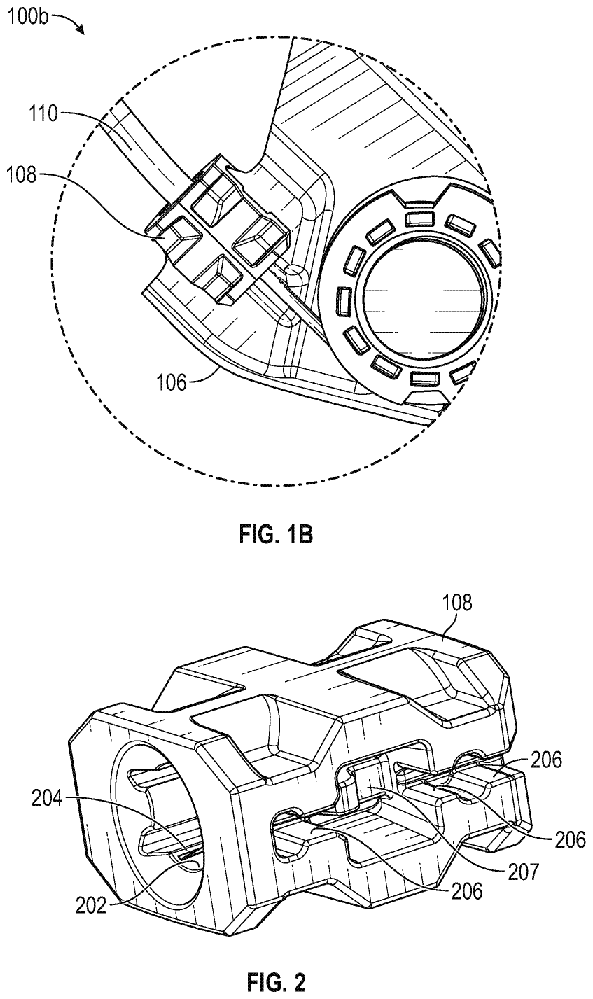

Referring to FIG. 1A is an example diagram 100a depicting a window regulator assembly for controlling the movement of a vehicle side door windows, in accordance with one or more exemplary embodiments. The diagram 100a depicting a window 102, a window regulator 104, guide rails 106, cable joints 108, cables 110, and window carriers 112. The guide rails 106 may include two guide rails configured to align in a parallel orientation. The cable joints 108 may be configured to enable the cables 110 connected with the guide rails 106. The window carriers 112 may be securely connected to the guide rails 106 and able to move along them, traveling both upwards and downwards. The window carriers 112 may include two window carriers configured to connect to the window 102. In some other embodiments, the window carrier 112 is snap-fitting to the hole on the window 102 or clamping down to the window 102 or fastening by screws to the window 102 with window bracket.

According to non-limiting exemplary embodiments, the cable joint design may be utilized not only for window regulators but also for other applications that involve cable connections, such as seat control cables, hood release cables, and so on.

The present invention is not limited to any particular application and can be utilized in a wide array of industries. It is adaptable and can be integrated into existing systems or used as a standalone solution. The invention's broad applicability ensures that it can address a multitude of challenges and is adaptable to meet diverse needs.

Referring to FIG. 1B is an example diagram depicting a detailed view of the guide rail, in accordance with one or more exemplary embodiments. The diagram 100b depicting a guide rail 106. The guide rail 106 may be clamped by the cable joint 108 using one or more grooves 206 (As shown in FIG. 2).

Referring to FIG. 2 is an exemplary diagram 200 depicting the cable joint, in accordance with one or more exemplary embodiments. The diagram 200 depicting the cable joint 108. The cable joint 108 may include a cable insertion cavity 202, crash ribs 204, grooves 206 and snap arms 207.

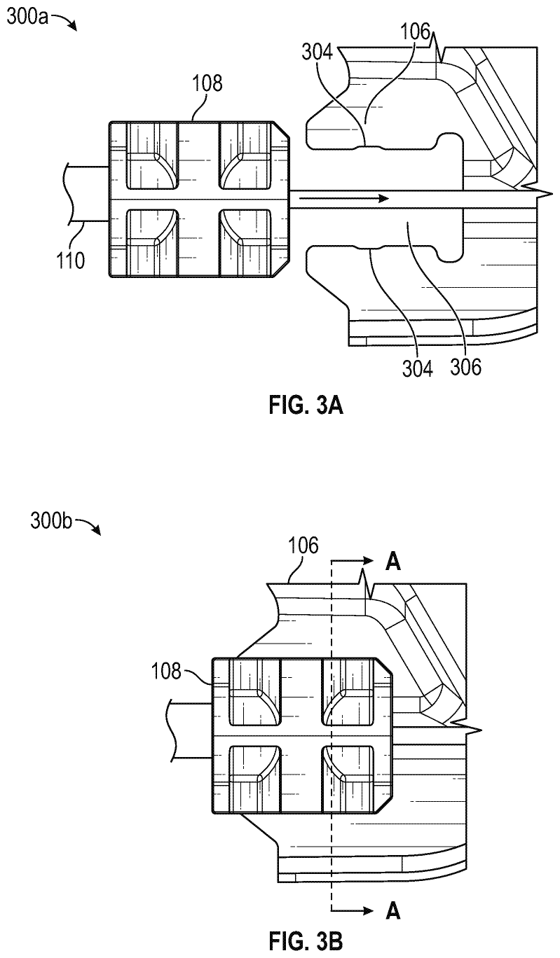

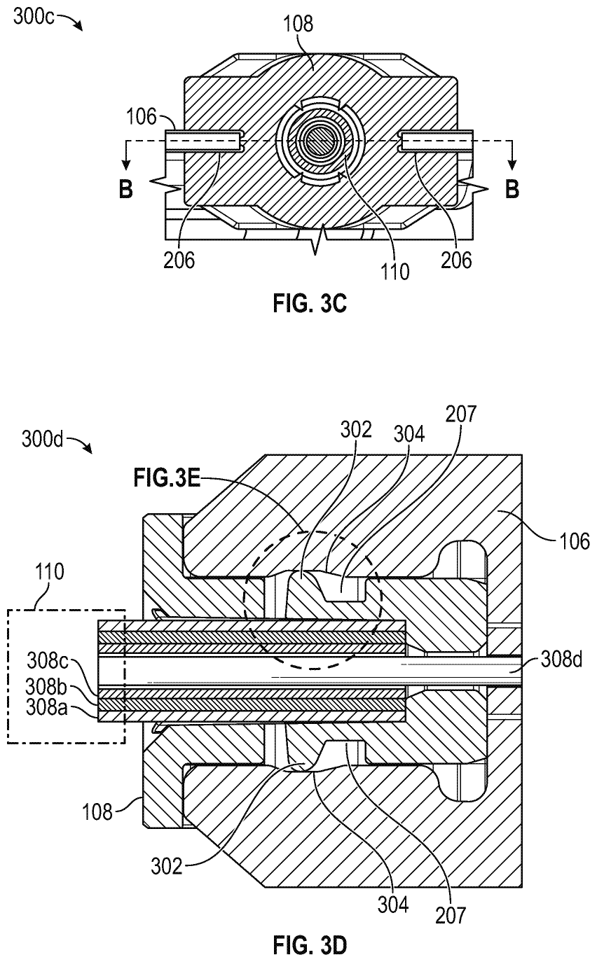

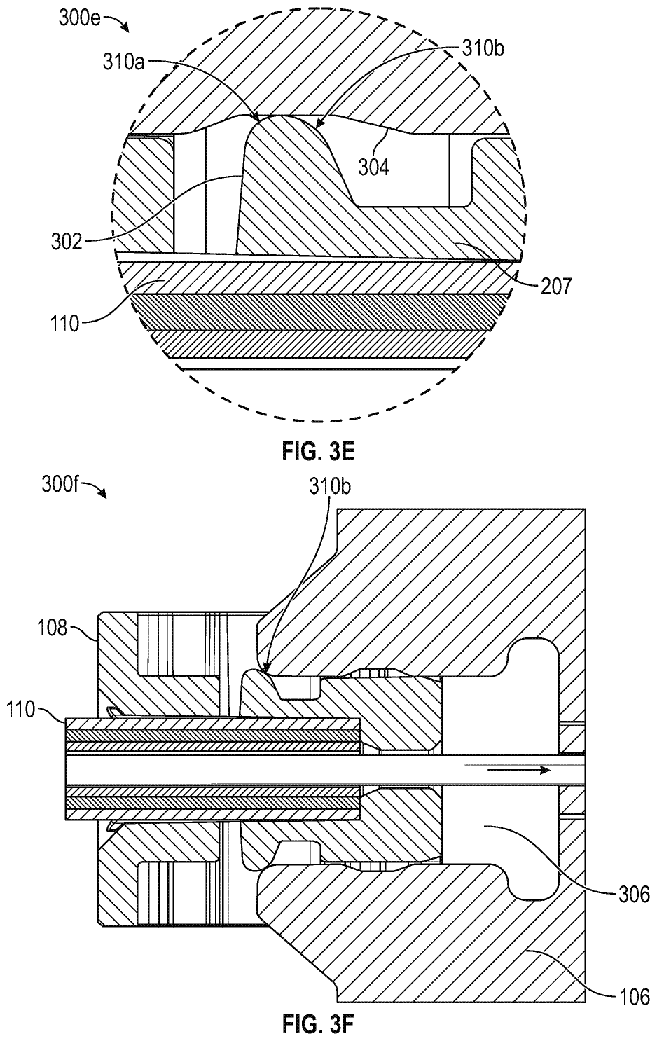

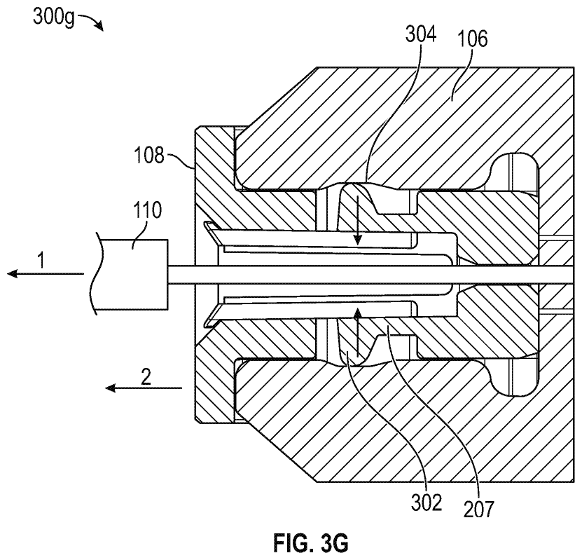

The cable insertion cavity 202 and the crash ribs 204 may be configured to enable the cable to attach with the cable joint 108. The grooves 206 may be configured to be positioned on the guide rail 106 (As shown in FIG. 3C/SEC. A-A).

Referring to FIG. 3A is an exemplary diagram 300a depicting the cable joint 108 and the guide rail 106, in accordance with one or more exemplary embodiments. The diagram 300a depicting the cable joint 108 comprising the first locking member, and the guide rail 106 comprising a second locking member. The first locking member may include but not limited to grooves 206, snap arms 207, and projections 302. The second locking member may include but not limited to a slot 306 and notches 304. The projections 302 of the first locking member positioned inside the cable joint 108 may be configured to engage with the notches 304 of the second locking member thereby forming a snap-fit joint onto the guide rail 106 temporally (As shown in FIG. 3D/SEC. B-B).

Referring to FIG. 3B is an exemplary diagram 300b depicting the cable joint 108 engaged with the guide rail 106, in accordance with one or more exemplary embodiments.

Referring to FIG. 3C is an exemplary diagram depicting section view A-A of a cable joint 108 engage with the guide rail 106, in accordance with one or more exemplary embodiments. The FIG. 3C/SEC.A-A depicting a guide rail 106, a cable joint 108, a cable 110, and one or more grooves 206.

Referring to FIG. 3D is an exemplary diagram 300d depicting a cable joint 108 engaging with a guide rail 106, in accordance with one or more exemplary embodiments. The FIG. 3D/SEC.B-B depicting a cable 110, a first locking member comprised in the cable joint 108, and a second locking member comprised in the guide rail 106. The cable 110 may include a jacket 308a, a spring 308b, a liner 308c, and a core cable 308d. The jacket 308a, the liner 308b, and the spring 308c may be configured to shield the core cable 308d. The jacket 308a of the cable 110 may be made of elastic material and designed to deform and compress when the projections 302 and snap arms 207 of the first locking member is compressed by the second locking member. This facilitates the passage of the projections 302 of the first locking member through the slot 306 of the second locking member on the guide rail 106 as shown in the FIG. 3F. The elastic material may include but not limited to polyvinyl chloride or other suitable materials like soft and flexible plastic, and rubber-like materials for making the jacket 308a of the cable 110.

The projections 302 of the first locking member are positioned inside the cable joint 108 in such a way that when one or more projections 302 of the first locking member become disengaged from the notches 304 of the second locking member. The cable joint 108 may be configured to exert pressure on the cable 110. The purpose of exerting this pressure is to prevent cable joint 108 from becoming dislodged or detached from the slot 306 of the guide rail 106. By exerting pressure on the cable 110 during the disengagement of the locking members, the cable joint 108 ensures a secure and stable connection, minimizing the risk of accidental detachment or movement.

Referring to FIG. 3E is an exemplary diagram 300e depicting a first slope 310a and a second slope 310b of the projections 302 of the first locking member of the cable joint 108, in accordance with one or more exemplary embodiments. The diagram 300e depicting the cable 110, the first locking member. The first locking member may include but not limited to snap arms 207 and projections 302. The projections 302 of the first locking member may include the first slope 310a and the second slope 310b. The first slope 310a may form steep angle slopes and the second slope 310b may form slight angle slopes. The first slope 310a may be situated on the opening side of the second locking member and the first slope 310a form a steep angle that may be configured to prevent the cable joint 108 from coming out from the guide rail 106. The second slope 310b may be situated on the closing side of the second locking member and the second slope 310b form a slight angle that may be configured to push the cable 110 and cable joint 108 into the slot 306 of the second locking member of the guide rail 106 as shown in the FIG. 3F.

Referring FIG. 3F is an exemplary diagram depicting inserting a cable 110 into a cable joint 108, in accordance with one or more exemplary embodiments. The FIG. 3F depicting a guide rail 106, a cable 110, a cable joint 108, and a slot 306 of the second locking member, a second slope 310b of the projections 302.

Referring to FIG. 3G is an exemplary diagram depicting a cable joint 108 that engaging to a guide rail 106 after removing a cable 110, in accordance with one or more exemplary embodiments. When the user removes the cable joint 108 from the guide rail 106, simply start by removing the cable 110 to create a room and allow snap arms 207 to bent and disengage the projections 302 from the notches 304, and then the cable joint 108 can be easily taken out.

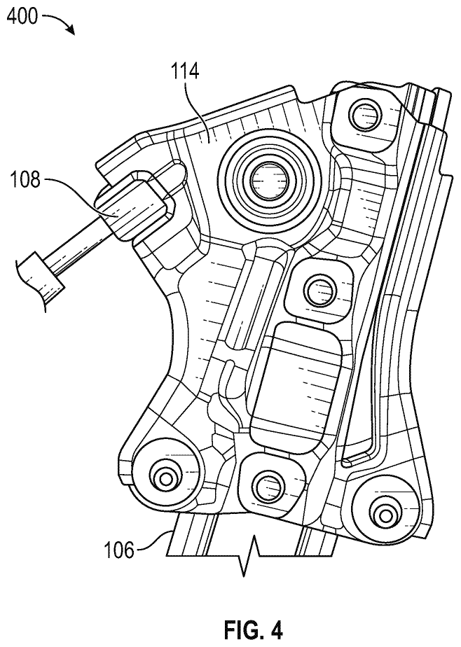

Referring to FIG. 4 is another example of diagram 400 depicting the window regulator guide rail assembly with a guide rail bracket 114 comprising the second locking member for controlling the movement of windows, in accordance with one or more exemplary embodiments.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A cable joint for securely connecting a cable to a guide rail of a window regulator assembly comprising:
a first locking member configured to engage with a second locking member, wherein the first locking member comprises one or more snap arms with projections, and the second locking member comprises a slot and one or more notches, whereby the one or more projections configured to engage with the one or more notches thereby forming a snap-fit joint onto the guide rail temporally;
at least one projection of the first locking member configured with a first slope and a second slope, whereby the first slope comprises a steep angle configured to prevent the cable joint from coming out from the guide rail, the second slope comprises a slight angle configured to push the cable joint into the slot of the guide rail.

2. The cable joint of claim 1, wherein the cable joint is made of plastic, thereby allowing the first locking member to be flexible.

3. The cable joint of claim 1, wherein the second locking member is positioned on a guide rail.

4. The cable joint of claim 1, there is minimum clearance between snap arm and cable, wherein the cable joint is configured to exert pressure on the cable as one or more projections of the first locking member disengage from the notches of the second locking member, thereby preventing the cable joint from dislodging from the slot of the guide rail.

5. A cable joint of claim 1, wherein the cable joint further comprising:
a cable insertion cavity is configured to insert the cable, whereby the cable comprises a spring, a liner, and a jacket, wherein the jacket is made of elastic material and configured to undergo deformation and compression when at least one projection of the first locking member is compressed, thereby facilitating the passage of one or more projections of the first locking member through slots on the guide rail.

6. The cable joint of claim 1, wherein the first locking member configured to easily disengage from one or more notches of the guide rail by removing the cable from the cable joint.
